(19) United States
(12) Patent Application Publication
(10) Pub. No.: US 2013/0279723 A1
(43) Pub. Date: Oct. 24, 2013

(54) ARRAY LOUDSPEAKER SYSTEM

(71) Applicants: Anthony Hooley, Cambridge (GB); Edgar Yazid Choueiri, Princeton, NJ (US); Paul Raymond Windle, Cambridge (GB)

(72) Inventors: Anthony Hooley, Cambridge (GB); Edgar Yazid Choueiri, Princeton, NJ (US); Paul Raymond Windle, Cambridge (GB)

(73) Assignee: CAMBRIDGE MECHATRONICS LIMITED, Cambridge (GB)

(21) Appl. No.: 13/820,810

(22) PCT Filed: Sep. 2, 2011
(86) PCT No.: PCT/GB11/51655

§ 371 Date: Jun. 25, 2013

(30) Foreign Application Priority Data
Sep. 6, 2010 (GB) 1014769.2
Dec. 15, 2010 (GB) 1021250.4

(51) Int. Cl. H04R 5/02

(52) U.S. Cl. CPC H04R 5/02
USPC 381/304

(57) ABSTRACT

A sound reproduction system for producing sound and 3D sound at the listener position by directing beams from an array loudspeaker using differential apodisation. Optionally, cross-talk cancellation is applied to beams directed to the listener's left and right ears.

The present invention is directed to loudspeaker arrays and methods of using loudspeaker arrays. More particularly, the present invention is aimed at ways of improving the sound quality achievable with such arrays.

Array Loudspeakers are known in the art (e.g. see U.S. Pat. No. 7,577,260). An array loudspeaker comprising a digitally controlled delay-array of acoustic transducers are able to simultaneously form several/many selectively directed and focussed beams of sound each carrying a different channel of acoustic information (e.g. in 3.1, 5.1, 7.1, 9.1 etc. configurations for front-stereo, 5.1-surround, etc). The separate beams may be used to direct sounds at the user either directly, or from different directions by bouncing them off walls, floors and ceilings, or other sound-reflective surfaces or objects. In normal use of an array loudspeaker for creating a surround-sound sensation, the front-channel signal is directed straight at the listening area (wherein are the listeners) with the beam focal-length set to a fixed distance chosen to optimise the even distribution of that channel's sound amongst the listeners (often this is best set at a negative focal length, i.e. giving a virtual focus positioned behind the transducer array); the front-left and front-right channel signals are commonly directed to the listening area via a left and right wall-bounce (respectively), so that the dominant sounds from these channels reach the listeners from the direction of the walls, greatly enhancing the sense of separation of the left and right channels, and providing a wide spatial listening experience; the rear-left and rear-right channels are commonly bounced off the sidewalls (and where the array loudspeaker allows for vertical beam-steering as well as horizontal beam-steering, off the ceiling too) and subsequently off the rear walls to finally reach the listening area from a direction opposite to the array loudspeaker (i.e. from behind the listeners), to give a strong sense of “surround-sound”. In all of these situations it is usual that once set-up, the directions, gains, frequency responses and focal lengths of all channel sound beams are fixed for the duration of a listening session, unless the user actively intervenes to modify them manually (e.g. via a remote control).

The human ear/brain system determines the direction of incoming sounds by attending to the subtle differences between the signals arriving at the right and left ears, primarily the amplitude difference, the relative time-delay, and the differential spectral shaping. All these effects are caused by the geometry and physical structure of the head—primarily because this places the two ear apertures at different positions in space, and with differential shadowing, absorbing and diffracting structures between the two ears and any source of sound. The differences in response between the two ears are summarised as a Head Related Transfer Function (HRTF), a function of frequency and angular position of sound source relative to some reference, e.g. straight ahead in the horizontal plane. It follows from the way this HRTF is defined, that if a source of sound is delivered to the region of each ear of a listener with a difference between the ear-signals identical to the HRTF for a particular sound-source direction THETA (a 3D ANGLE), then the listener will perceive the location of the sound as being direction THETA, even though it might be delivered directly to the ears by headphones for example. Such HRTF-based sound delivery to both ears may be well described as 3D-sound, in the sense that if accurately done, the listener can perceive a complete 3D sound-scape, real or completely synthetic.

Many ways of delivering HRTF-based 3D sound (hereinafter just 3DSound) are proposed in the art. As described above, the simplest is perhaps via headphones, though this is often inconvenient for the listener in practice, difficult at all if the listener is moving, and requires multiple sets of headphones for multiple listeners.

Also, with headphones, if the listener moves her head then she will have an unsettling perception of the sound-field moving with her head, which breaks the spell and no longer sounds ‘real’. The one key advantage of headphone delivery of 3DSound is that it is simple to almost completely eliminate cross-talk between the two ear signals—one can precisely deliver the left signal to the left ear and the right signal to the right ear.

To avoid the practical issues of delivering 3DSound to a listener or listeners with headphones, many methods are proposed in the art for delivering 3DSound with two or more loudspeakers, remote from the listener. When this is done the principal new problem to be solved is the reduction of cross-talk between the two ear-signals, such that the left ear hears more or less just the left signal, and ditto for the right, even though both ears are now exposed to both loudspeakers. This problem and its solutions are generically known as Cross-Talk-Cancellation (XTC). If two loudspeakers are used for delivering 3DSound then they are necessarily separated by a minimum distance Dmin determined by the physical dimensions of the loudspeakers (and similar considerations apply for more than two loudspeakers). Where small separations are desirable, as in e.g. the well known Stereo Dipole XTC implementation, then the size of the loudspeakers to be used is limited by the desired separation, which in turn has negative implications for the deliverable sound quality and amplitude.

Most XTC solutions for the delivery of 3DSound make the assumption that the delivery and listening of sound take place in an essentially anechoic setting, so that the only signals to be crosstalk-cancelled arise directly from the loudspeakers. However, in reality most practical listening environments contain reflective and diffractive objects, and are generally surrounded by one or more walls, a floor and a ceiling. In such real environments, scattered sound arriving at the listener's ears indirectly—i.e. from the loudspeakers via one or more reflections/diffractions from objects and/or floor/walls/ceiling—can have a very significant magnitude as compared to the direct sound from the loudspeakers, and in such cases the degree of XTC achievable with conventional equipment drastically falls, often to unworkable levels. This problem is exacerbated by the largely omnidirectional characteristics of most discrete loudspeakers—the physics of acoustic transducers ensures that where the radiating portion of a loudspeaker is significantly smaller than a wavelength of the sound being emitted, then its radiation is distributed more or less uniformly in all directions (at least, it will have a very wide beam angle). As the wavelength of a frequency equivalent to middle C on the musical scale is around four feet (well over a metre) it becomes clear that even moderately large hi-fi speakers (say 8-inch cones) are nominally omnidirectional up to frequencies of well over 1 KHz. The implication is that real, practical loudspeakers used for 3DSound delivery to a listener, will also distribute the sound more or less all around the listening room too, resulting in very large unwanted backscatter to the listener's ears, and greatly diminishing the effectiveness of any of the forms of XTC known in the art. While in principle it is conceivable to tune an XTC process for a particular listening room, and for a particular position of the loudspeakers and listener in that room, such a process would be complex, cumbersome and unlikely to produce significantly improved results, as well as being impractical for most listeners.

Image analysis and segmentation and object identification processes are also known in the art, which when applied to video signals representative of a real 3D scene, are able to extract more or less in real-time, image features relating to one or more objects in the scene being viewed. These are nowadays for example commonly found in video cameras able to identify one or more people (or perhaps just faces of people) in a scene, to identify the locations of those people (e.g. by displaying a surrounding-box on the camera's display-screen) and even in some cases to determine which of the people in the image are smiling or winking.

The present invention provides a system having a loudspeaker array comprising multiple transducers distributed at least partly in a left-to-right direction and configured to produce at least a left sound beam and a right sound beam; wherein said system is configured so that:
said left sound beam is directed in a first direction with a first apodisation pattern;
said right sound beam is directed in a second direction with a second apodisation pattern;
said first direction and said second direction have different components in said left-to-right direction; and
at least one of said first and second apodisation patterns is asymmetrical about a vertical axis passing through the centre of the loudspeaker array.

The asymmetrical apodisation for at least one of the directed beams provides a better sense of beam separation for the user, providing a better stereo or surround sound effect when implemented in a stereo or surround sound system.

Optionally, the first and second apodisation patterns are each asymmetrical about a vertical axis passing through the centre of the loudspeaker array. In the preferred embodiment, both of two beams are asymmetrically apodised.

Optionally, the first and second apodisation patterns are different from one another.

Optionally, the first direction is towards the left and the second direction is towards the right. This is the preferred set-up.

Optionally, the beams are differentially apodised such that they appear to originate from different parts of the array.

Optionally, the apparent location of the source of the beams of sound is off-centre. Optionally, the apparent location of the source of the left beam of sound is left of centre and the apparent location of the source of the right beam of sound is right of centre.

Optionally, said loudspeaker array comprises multiple transducers distributed in a regular pattern. Alternatively, an irregular arrangement may be used.

Optionally, said loudspeaker array comprises multiple transducers distributed in a horizontally disposed row.

Optionally, said first and second apodisation patterns are each a window function having a peak value with smooth attenuation away from the peak value.

Optionally, said first and second apodisation patterns are selected from the following window functions:
(a) Hann window;
(b) cos window;
(c) Hamming window;
(d) Kaiser window;
(e) Chebyshev window.

Optionally, each beam carries a different component of a 3D sound programme and cross talk cancellation (XTC) is applied. Known XTC algorithms may be used.

Optionally, said left beam is directed towards the left ear of a listener and said right beam is directed towards the right ear of a listener.

Optionally, one or more of the transducers at the left-hand end of the array is disconnected from the right beam signal, and optionally one or more of the transducers at the right-hand end of the array is disconnected from the left beam signal, or vice versa.

The invention further includes a method of directing a left sound beam and a right sound beam using a loudspeaker array comprising multiple transducers distributed at least partly in a left-to-right direction; said method comprising:
directing said left sound beam in a first direction with a first apodisation pattern;
directing said right sound beam in a second direction with a second apodisation pattern;
wherein said first direction and said second direction have different components in said left-to-right direction; and
wherein at least one of said first and second apodisation patterns is asymmetrical about a vertical axis passing through the centre of the loudspeaker array.

Optionally, said first and second apodisation patterns are each asymmetrical about a vertical axis passing through the centre of the loudspeaker array.

Optionally, the first and second apodisation patterns are different from one another.

Optionally, said first direction is towards the left and said second direction is towards the right.

Optionally, the beams are differentially apodised such that they appear to originate from different parts of the array.

Optionally, the apparent location of the source of the beams of sound is off-centre.

Optionally, the apparent location of the source of the left beam of sound is left of centre and the apparent location of the source of the right beam of sound is right of centre.

According to an embodiment of the invention, the effective source position of the beam or beams intended for the left ear are positioned differently relative to the effective source position of the beam or beams intended for the right ear, by differently apodising (windowing) the array for the left ear and right ear beams.

According to an optional feature of the invention, the array loudspeaker is used to deliver 3DSound to a listener. This can be achieved by applying a cross-talk cancellation (XTC) function to the signals to be transmitted by the array, and this may involve using one or more head-related transfer functions (HRTF).

The invention will now be further described, by way of non-limitative example only, with reference to the accompanying drawings, in which:

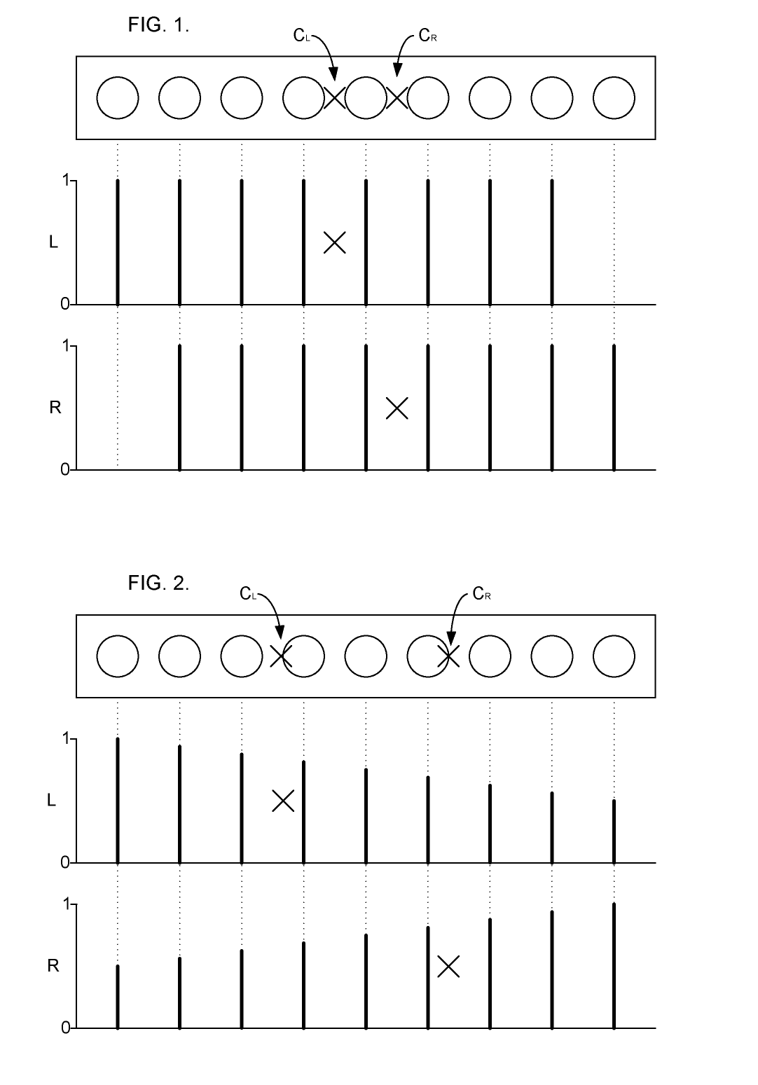

FIG. 1 shows a horizontal line array and corresponding apodisation pattern for left and right beams according to a first embodiment of the invention;

FIG. 2 shows a horizontal line array and corresponding apodisation pattern for left and right beams according to a second embodiment of the invention;

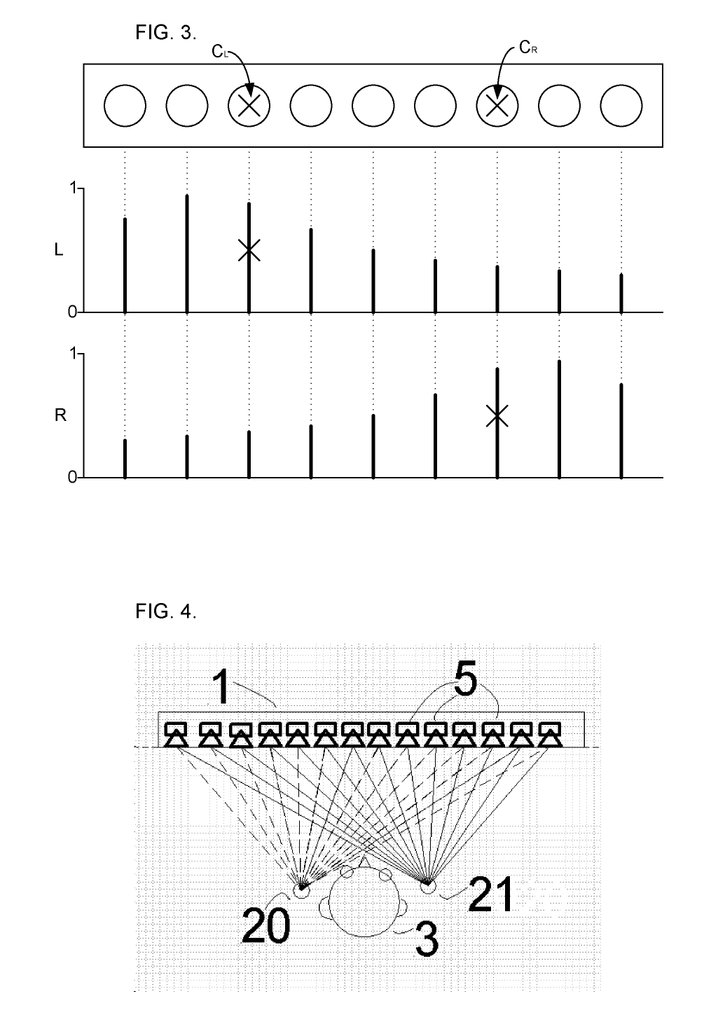

FIG. 3 shows a horizontal line array and corresponding apodisation pattern for left and right beams according to a third embodiment of the invention;

FIG. 4 shows a plan view of a loudspeaker array with left and right sound beams being directed to the vicinity of a listener's left and right ears, respectively.

Loudspeaker arrays can be used to direct beams in specific directions so that the beams follow specific paths. We have previously disclosed in WO01/23104 and WO02/078388 using a loudspeaker array to direct at least left and right sound beams along different paths. The paths may be such as to route sound direct to a listener. However, an excellent effect can be provided by selecting a path involving a wall-bounce, such that the left sound beam approaches the listener from the direction of a left side wall and the right sound beam approaches the listener from the direction of the right wall. The disclosures of these documents are incorporated herein by reference and the present invention is applicable to systems where the paths include a wall bounce, as well as systems where direct paths are used.

The first to third embodiments of the invention will be described with reference to a horizontally disposed line array. This type of array has a single line of output transducers (i.e. loudspeakers) arranged along the horizontal direction. At least two transducers are required and preferably there are several transducers. FIGS. 1 to 3 show nine transducers but more or fewer may be used in practice. For example, at least 6, preferably at least 10, more preferably at least 15 and most preferably at least 20 transducers are used. The invention is equally applicable to two-dimensional arrays, which have transducers extending also in the vertical direction. Whether linear or two-dimensional arrays are used, it is convenient for the transducers to be arranged in a regular pattern. For line arrays, this means that the spacing between adjacent transducers is constant. For two-dimensional arrays, this means that the spacing is consistent, for example by using a square or triangular lattice of transducers. Alternatively, the transducers can be arranged irregularly, which can have a useful effect as discussed in WO03/034780 and WO2006/030198.

Apodisation functions are per se known for loudspeaker arrays. They have been shown to be effective in reducing sidelobes that can manifest themselves when seeking to direct sound beams. “Sidelobes” are unwanted sound beams that travel in unwanted directions. The apodisation functions disclosed in the prior art are symmetrical about the vertical centreline of the array and are applied in the same way for left sound beams as right sound beams. This is because the function of such apodisation functions was to reduce sidelobes and the best sidelobe reduction is provided with centred and identical apodisation functions.

If the apodisation function A(x,y) for a beam is symmetric about the centre of the physical array (in a 1-D or 2-D array), the effective source position for that beam will be the centre of the physical array. More precisely for a line-array with N transducers, where the ith transducer TXᵢ has position along the array Xᵢ and relative gain Gᵢ, the acoustic centre of the array XAc is equal to the first-moment Mx of the gains of the totality of transducers each weighted by their respective apodisation parameters A where 0<=Aᵢ<=1.

Mx=G₁.X₁.A₁+G₂.X₂.A₂+ . . . +G_{N}.X_{N}.A_{N}.

However, if the apodisation function A(x,y) for a beam is asymmetric about the centre of the physical array, for example, has more total weight towards the left of centre of the array, then the effective source position (or acoustic centre as defined above) for that beam will be left of the centre of the physical array. By suitable adjustment of the transducer weights Aᵢⱼ for each of 1 to j beams (the beam apodisation weights), the effective source position of each beam may be adjusted to be anywhere within the outline of the array, though the closer to the edge of the physical array a source position (acoustic centre) is moved, then the weaker the total radiated power will usually be as many weights will then usually be less than unity. By using beam-dependent apodisation functions for each of the two or more beams produced by the array, the beam source positions (i.e. the beam acoustic centres) within the array may be adjusted. This can be used to provide stereo separation effects and is particularly useful when optimising the XTC. The invention can thus achieve optimal listener perception of true stereo/3D sound.

Accordingly, the invention in one aspect provides for at least one asymmetrical apodisation pattern. This allows the effective source position for left and right beams to be offset from each other, helping to further reduce crosstalk. Preferably, the apodisation patterns are each asymmetrical and are different for the left and right beams. The left beam and right beam are preferably directed in different directions and this serves to further enhance the feeling of sound separation.

In present state of the art two-loudspeaker HRTF XTC systems, the two separate sources of sound are necessarily spatially-separated from each other as they are emitted by two separate loudspeakers. However, in order to produce significant differences in the signals arriving at the right and left ears of the listener, the two sources must be in any case spatially separated, along the horizontal direction at right angles to the direction towards the listener. Because small loudspeakers are more or less non-directional over the frequencies of interest, were there no such L-R spatial source separation, the signals arriving at the listener's two ears would be more or less identical, and very little XTC could be achieved.

When an array loudspeaker is used instead of a pair of small sources, this can be arranged to have significant physical extent in the L-R direction normal to the listener-direction, and can be made to have significant directionality in the plane through the array and the listener's head. Using the whole (unapodised) array to produce the two beams, one beam for each of the L and R signals, results in exact coincidence of the L and R source locations (acoustic centres), quite different from the discrete two-speaker source case, where this effect is practically impossible; in such a situation were both beams to be directed straight at the listener's head, there again would be no possibility of producing significant XTC. The array, however, allows the two beams to be steered in different directions, for example, the L-beam to the vicinity of the listener's L-ear, and the R-beam to the vicinity of the listener's R-ear, and because of the relatively narrow beam widths possible with an array of appropriate length, these two beams can produce significantly different signals to the listener's L and R ears, and good XTC is achievable, even with physically coincident L and R source locations (i.e. both source locations at the acoustic centre of gravity of the array). This L-R ear signal separation effect may be further enhanced by focussing the L and R beams at distances from the array similar to the distances of the corresponding listener's L and R ears.

Because in practice the two steered beams still overlap somewhat in the vicinity of the listener's ears, even when steered to appropriately different locations, it is possible to further enhance the system by also separating the beam source locations along the line of the array. A simple way to achieve this is to disconnect one or more of the array transducers at the R-hand end of the array from the L-beam, and optionally to similarly disconnect one or more of the array transducers at the L-hand end of the array from the R-beam, or vice-versa. This has the effect of offsetting the effective source location of the L-beam to a position left of centre of the array, and offsetting the effective source location (acoustic centre) of the R-beam to a position right of centre of the array. With such an arrangement, even directing both beams straightforward (normal to the plane of the array) when the listener is more or less on-axis (or directly towards the listener, wherever she happens to be positioned) some L/R-ear XTC is achievable in a manner similar to the conventional two-speaker arrangement, but with the added advantage that the array's directionality sends much less sound to other parts of the listening room and so enhances the overall XTC because of the reduced back-scatter that ensues. Combining this method of L & R source separation, with steering of the beams differentially (i.e. each to the appropriate ear of the listener) further enhances the level of XTC achievable. A side-effect of disconnecting one or more transducers from one or both beams is that the directionality of the shortened array(s) so formed is reduced compared to that of the full-array, thus increasing the spillover of the beam(s) to the opposite ear (i.e. left beam to right ear and vice versa) which then compromises the level of XTC achievable. A further side-effect is to reduce the maximum SPL (Sound Pressure Level) achievable by each such reduced-array, all else being equal. These compromises can be carefully judged in each situation (i.e. with each specific array design, desired-frequency band of XTC, and desired listener SPL) so as to retain the best features of beam-width and source separation.

Beams conditioned to be suitable for transmission to the left and right ears can be termed left-ear-beam and right-ear-beam, or LE-beam and RE-beam. These LE and RE beams differ from conventional L and R stereo channels in that they carry HRTF and XTC signals rather than pure left and right channel information.

In one form the invention includes an array-loudspeaker comprising multiple loudspeaker-transducers distributed at least partly in a left-to-right direction, preferably used in a phased-array or broadband digital-delay array manner to form at least two beams of sound. The beams can be denoted L-beam and R-beam or denoted LE-beam and RE-beam if they include XTC coding. As such, the LE-beam and RE-beam carry respectively left (L) and right(R) signals comprising HRTF (Head Related Transfer Function) XTC (Cross-Talk Cancelled) signals.

Preferably, both the L or LE-beam and the R or RE-beam are directed towards the vicinity of the corresponding listener's L and R ears.

FIG. 1 shows an exemplary line array having nine transducers. It also shows a first embodiment of apodisation pattern for the left sound beam (marked “L”) and right sound beam (marked “R”). The apodisation pattern is a weighting applied to each signal that is routed through each transducer. A weighting of one implies that the signal is left to take it's normal value and a weighting of zero implies that the signal is blocked. A weighting in between zero and one implies a level of attenuation between zero attenuation and no attenuation. According to the first embodiment, all the transducers are set to have an apodisation weighting of one, except for the farmost ends of the array. At the left end of the array, the lefthand transducer passes the left beam signal without attenuation (weighting=1) and blocks the right beam signal (weighting=0). At the right end of the array, the righthand transducer passes the right beam signal untouched (weighting=1) and blocks the left beam signal (weighting=0). This corresponds to disconnecting the left transducer for the right beam and vice versa, as discussed above. This has the effect of moving the effective centroid for the left sound beam to the left and moving the effective centroid for the right sound beam to the right. This is shown in FIG. 1 where the centroid for the left sound beam is schematically denoted C_{L} and the centroid for the right sound beam is schematically denoted C_{R}. As shown in FIG. 1, disconnecting the farmost transducers differently for each beam creates an effective apodisation pattern that is different for the two beams. Although in this embodiment, the farmost transducer for each beam is disconnected, it can be arranged so that the farmost two or three transducers are instead disconnected, and this would serve to separate the centroids C_{L} and C_{R} by a yet further amount.

More complex ways to achieve effective L-R source separation for the two beams include applying a more complex apodisation function to the gain of one or more of the per-transducer channels for each of the L and R beams, where the L and R beam apodisation functions are different from each other. Thus, for example, non-integral weighting functions may be used, and in general so long as the weighted acoustic centres of gravity of the L & R beam arrays have a positive L-R separation, then effective L-R source location separation is achieved.

According to a second embodiment of the invention, a linear weighting function starting at 1.0 at the leftmost transducer reducing to 0.5 at the rightmost transducer, for the L-beam, and a linear weighting function starting at 1.0 at the rightmost transducer reducing to 0.5 at the leftmost transducer, for the R-beam, is provided. This is shown schematically in FIG. 2. As can be seen, this provides a greater degree of source separation than the first embodiment because C_{L} and C_{R} and farther apart from one another in FIG. 2 than they are in FIG. 1.

Other considerations for the form of these array weighting functions can include the loss in maximum achievable SPL as described above, and optionally whether any attempt at beam-shaping to reduce side-lobes is included, though this is not necessary for this application. The primary goal is maximum SPL at each ear consistent with maximum XTC between the ears, and both these especially when the echoics/acoustics of the surrounding listening room are included.

FIG. 3 shows a third embodiment of the invention, in which non-linear apodisation functions are used. This function is characterised as a curve with a peak value and smooth attenuation away from the peak value. As can be seen from FIG. 3, the peak for the left sound beam is located at the left side of the array and the peak for the right sound beam is located at the right side of the array. This provides an even greater level of sound source separation than the first and second embodiments described above. Further, the curved shape of the apodisation function serves to limit sidelobes in the sound beams. Curves such as Gaussian curves, Hann windows, cosine windows, Hamming windows, Kaiser windows and Chebyshev windows among others may be used.

While the apodisation scheme is extremely useful when combined with HRTF and XTC signals, it should be noted that the use of differentially apodised separated beams provides the benefits of source separation also in other applications, such as conventional stereo for simple left and right channels and as a component of 3-D sound systems. In such differentially apodised schemes, at least two beams are produced which appear to emanate from different parts of the array. In particular one or both beams may be off-centre, that is they emanate from off-centre parts of the array. For example, a left beam appears to emanate from the part of the array to the left of the centre of the array and a right beam from the part of the array to the right of the centre. Further beams may be added, for example emanating from other parts of the array or emanating from the same parts of the array as the initial two beams.

According to the present invention, an array loudspeaker can be used (instead of two or more discrete conventional loudspeakers), to deliver 3DSound to a listener's ears, by directing two or more of its beams (each carrying different components of the 3DSound) towards the listener. The overall size of the array loudspeaker is chosen such that it is able to produce reasonably directional beams over the most important band of frequencies for 3DSound to be perceived by the listener, for example from say 200-300 Hz up to 5-10 KHz. So for example, a 1.27 m (approx 50 inches-matched to the case size of a nominal 50-inch diagonal TV screen) might be expected to be able to produce a well-directed beam down to frequencies below 300 Hz. The experimentally measured 3 dB beam half-angle at a distance of ˜2 m is about 21 deg when unfocused, which is much less than the nearly 90 deg half-angle beam of a small single transducer loudspeaker. When focussed at ˜2 m in front of the array the half-angle beamwidth reduces to ˜15 deg. At 1 KHz the measured beam half-angle reduces to less than 7 deg when the beam is focussed at ˜2 m in front of the array. Clearly, with such narrow beamwidths the proportion of radiated sound from the array being diffusely spread around all the scattering surfaces in the listening room is greatly reduced over the small-discrete-loudspeaker case. The net effect is that any XTC implementation will have a much greater chance of achieving acceptable cross-talk levels.

In the present invention, the array loudspeaker can be used to deliver sound or 3DSound to a listener, with the added feature that the beam or beams carrying information for the left ear are directed towards the left ear of the listener, and the beam or beams carrying information for the right ear are directed towards the right ear of the listener. In this way the relative intensity at each ear of beams intended for that ear are increased relative to the opposing ear. The net effect is improved discrimination of the desired signals at each ear.

In the present invention the array loudspeaker can be used to deliver sound or 3DSound to a listener, with the added feature that the beam or beams directed towards the left ear of the listener are also focussed at a distance from the array corresponding to the distance of the listener's left ear from the array, and the beam or beams directed towards the right ear of the listener are also focussed at a distance from the array corresponding to the distance of the listener's right ear from the array. In this way the relative intensity at each ear of beams intended for that ear are further increased relative to the opposing ear.

In FIG. 4 an array loudspeaker 1 comprising an array of acoustic transducers 5, is in front of a listener 3, with one sound beam directed and focussed to a focal point 20 close to the left ear of the listener 3, and another sound beam directed and focussed to a focal point 21 close to the right ear of the listener. Because of the significant difference of the intensity of the two beams at their respective own focal points relative to the same beam intensities at the other beam's focal points, good listener channel-separation may be achieved, so that the listener 3 dominantly hears the first beam with her left ear (it being close to focal point 20), and dominantly hears the second beam with her right ear (it being close to focal point 21). Thus if the programme material on these two beams is representative of what the listener would have heard in each ear were she wearing headphones, then stereo sounds, and full surround sound signals prepared using HRTF information may be delivered remotely to the listener, without wires or headphones.

In the present invention the array loudspeaker can be used to deliver sound or 3DSound to a listener, with the added feature that another completely independent set of two or more beams is used to deliver sound or 3DSound to one or more additional listeners, by directing each additional set of beams towards the respective additional listener in a manner as described previously. Because of the linearity of an array loudspeaker additional beams are largely unaffected by the presence of other beams so long as the total radiated power remains within the nominally linear capabilities of each of the transducer channels. Furthermore, because the set of beams for each listener can be relatively localised to the vicinity of that listener by suitably directing and focusing the beams towards that listener, and by suitable sizing of the loudspeaker array for the frequencies/wavelengths of interest to achieve adequate beam directivity (i.e. suitably narrow beam angles), the additional beams will not cause unacceptable additional crosstalk to the other listener(s).

In the present invention, the array loudspeaker can be used as described above to deliver sound or 3DSound to one or more listeners, with the added feature that a video camera is used to view the listening room in the region where the listeners are situated, and to identify in real-time or near-real-time from the captured video image frames, the position relative to the loudspeaker array of one or more of the listeners, and for one or more of each such position-tracked listeners, to suitably adjust the direction of the two or more beams used to deliver 3DSound to that listener such that as and when that listener changes her position in the room, the associated beams are held in more or less the same relative position to the listener's head to appropriately optimise XTC at that listener's head. Thus, there can be provided a system wherein a video camera is used to detect the location of listeners and the sound beams are directed accordingly. Optionally, the position of one or more listeners is tracked by the video camera in real time and the sound beams are directed accordingly.

The XTC and HRTF used in the present invention may be according to known examples. Exemplary algorithms can be found in “Design of Cross-talk Cancellation Networks by using Fast Deconvolution”, Kirkeby et al, Department of Communication Technology, Aalborg University, Fr. Bajers Vej 7, 9220 Aalborg 0, Denmark or in “A Stereo Crosstalk Cancellation System Based on the Common-Acoustical Pole/Zero Model”, Wang et al, EURASIP Journal on Advances in Signal Processing, Volume 2010 (2010), Article ID 719197.

1. A system having a loudspeaker array comprising multiple transducers distributed at least partly in a left-to-right direction and configured to produce at least a left sound beam and a right sound beam; wherein said system is configured so that:
said left sound beam is directed in a first direction with a first apodisation pattern;
said right sound beam is directed in a second direction with a second apodisation pattern;
said first direction and said second direction have different components in said left-to-right direction; and
at least one of said first and second apodisation patterns is asymmetrical about a vertical axis passing through the centre of the loudspeaker array.

2. A system according to claim 1, wherein said first and second apodisation patterns are each asymmetrical about a vertical axis passing through the centre of the loudspeaker array.

3. A system according to claim 1, wherein the first and second apodisation patterns are different from one another.

4. A system according to claim 1, wherein said first direction is towards the left and said second direction is towards the right.

5. A system according to claim 1, wherein the beams are differentially apodised such that they appear to originate from different parts of the array.

6. A system according to claim 5, wherein the apparent location of the source of the beams of sound is off-centre.

7. A system according to claim 6, wherein the apparent location of the source of the left beam of sound is left of centre and the apparent location of the source of the right beam of sound is right of centre.

8. A system according to claim 1, wherein said loudspeaker array comprises multiple transducers distributed in a regular pattern.

9. A system according to claim 1, wherein said loudspeaker array comprises multiple transducers distributed in a horizontally disposed row.

10. A system according to claim 1, wherein said first and second apodisation patterns are each a window function having a peak value with smooth attenuation away from the peak value.

11. A system according to claim 1, wherein said first and second apodisation patterns are selected from the following window functions:
(a) Hann window;
(b) cos window;
(c) Hamming window;
(d) Kaiser window;
(e) Chebyshev window.

12. A system according to claim 1, wherein each beam carries a different component of a 3D sound programme and wherein cross talk cancellation is applied.

13. A system according to claim 1, in which said left beam is directed towards the left ear of a listener and said right beam is directed towards the right ear of a listener.

14. A system according to claim 1, wherein one or more of the transducers at the left-hand end of the array is disconnected from the right beam signal, and optionally one or more of the transducers at the right-hand end of the array is disconnected from the left beam signal, or vice versa.

15. A method of directing a left sound beam and a right sound beam using a loudspeaker array comprising multiple transducers distributed at least partly in a left-to-right direction; said method comprising:
directing said left sound beam in a first direction with a first apodisation pattern;
directing said right sound beam in a second direction with a second apodisation pattern;
wherein said first direction and said second direction have different components in said left-to-right direction; and
wherein at least one of said first and second apodisation patterns is asymmetrical about a vertical axis passing through the centre of the loudspeaker array.

16. A method according to claim 15, wherein said first and second apodisation patterns are each asymmetrical about a vertical axis passing through the centre of the loudspeaker array.

17. A method according to claim 15, wherein the first and second apodisation patterns are different from one another.

18. A method according to claim 15, wherein said first direction is towards the left and said second direction is towards the right.

19. A method according to claim 15, wherein the beams are differentially apodised such that they appear to originate from different parts of the array.

20. A method according to claim 15, wherein the apparent location of the source of the beams of sound is off-centre.

21. A method according to claim 20, wherein the apparent location of the source of the left beam of sound is left of centre and the apparent location of the source of the right beam of sound is right of centre.

22. A method according to claim 15, wherein said loudspeaker array comprises multiple transducers distributed in a regular pattern.

23. A method according to claim 15, wherein each beam carries a different component of a 3D sound programme and wherein cross talk cancellation is applied.

24. A method according to claim 15, in which said left beam is directed towards the left ear of a listener and said right beam is directed towards the right ear of a listener.

25. A system according to claim 1, wherein said loudspeaker array is arranged to provide that said left sound beam is directed in said first direction by providing a first plurality of said multiple transducers with a delayed signal corresponding to said left sound beam, with the delays being selected so that said left sound beam is directed in said first direction;
wherein said loudspeaker array is arranged to provide that said right sound beam is directed in said second direction by providing a second plurality of said multiple transducers with a delayed signal corresponding to said right sound beam, with the delays being selected so that said right sound beam is directed in said second direction.
